(19) United States
(12) Patent Application Publication
(10) Pub. No.: US 2025/0105351 A1
(43) Pub. Date: Mar. 27, 2025

(54) SOLID ELECTROLYTE FOR AN ALL-SOLID-STATE BATTERY

(71) Applicant: Arkema France, Colombes (FR)

(72) Inventors: Gerome GODILLOT, Lacq (FR); Christophe NAVARRO, Lacq (FR); Christine TARISSE, Lacq (FR); Anthony BONNET, Colombes (FR)

(21) Appl. No.: 18/727,723

(22) PCT Filed: Jan. 18, 2023
(86) PCT No.: PCT/FR2023/050062

§ 371 Date: Jul. 10, 2024

(30) Foreign Application Priority Data
Jan. 21, 2022 (FR) 2200536

(51) Int. Cl. H01M 10/0564; H01M 10/052; H01M 50/426

(52) U.S. Cl. CPC H01M 10/0564; H01M 10/052; H01M 50/426; H01M 2300/0065; H01M 2300/0085

(57) ABSTRACT

The present invention relates generally to the field of the storage of electrical energy in all-solid-state batteries, in particular in storage batteries of Li-ion type. More specifically, the invention relates to a solid electrolyte consisting of a polymer matrix and of a fibrous reinforcement which makes possible the manufacture of a non-porous film exhibiting a very good compromise between ion conductivity, electrochemical stability, high-temperature stability and mechanical strength. This film is intended for an all-solid-state battery separator application, in particular for Li-ion batteries. The invention also relates to an all-solid-state battery comprising such a separator and/or such an electrolyte.

### FIELD OF THE INVENTION

The present invention relates generally to the field of the storage of electrical energy in all-solid-state batteries, in particular in storage batteries of Li-ion type. More specifically, the invention relates to a solid electrolyte consisting of a polymer matrix and of a mechanical reinforcement which makes possible the manufacture of a non-porous film exhibiting a very good compromise between ion conductivity, electrochemical stability, thermal stability, mechanical strength and resistance to fire. This film is intended for an all-solid-state battery separator or electrolyte application, in particular for Li-ion batteries. The invention also relates to an all-solid-state battery comprising such a separator and/or such a non-porous film.

### TECHNICAL BACKGROUND

A Li-ion battery comprises at least one negative electrode or anode coupled to a copper current collector, a positive electrode or cathode coupled to an aluminium current collector, a separator and an electrolyte. The electrolyte consists of a lithium salt, generally lithium hexafluorophosphate, mixed with a solvent which is a mixture of organic carbonates, which are chosen in order to optimize the transportation and the dissociation of the ions. A high dielectric constant promotes the dissociation of the ions, and thus the number of ions available in a given volume, while a low viscosity promotes ion diffusion, which plays an essential role, among other parameters, in the rates of charging and discharging of the electrochemical system.

Lithium-ion batteries conventionally use liquid electrolytes composed of solvent(s), lithium salt(s) and additive(s). These electrolytes have a good ion conductivity but are liable to leak or catch fire if the battery is damaged.

The use of solid electrolytes makes it possible to overcome these difficulties. However, solid electrolytes are generally less conductive than liquid electrolytes. The difficulty for solid electrolytes is to reconcile a high ion conductivity, a good electrochemical stability and also a satisfactory temperature stability. The ion conductivity has to be equivalent to that of the liquid electrolytes (i.e. of the order of 1 mS/cm at 25° C.). The electrochemical stability has to make possible the use of the electrolyte with cathode materials which can operate at high voltage (>4.5 V). Likewise, the solid electrolyte has to operate at least up to 80° C. and not catch fire below 130° C.

Furthermore, a satisfactory mechanical strength has to be obtained at the separator. The latter in particular has to prevent the formation of dendrites during the charging/discharging cycles.

Generally, the solid electrolyte has to demonstrate better safety but this cannot be achieved to the detriment of the other performance qualities.

Finally, from a processability and implementation viewpoint, the solid electrolyte has to be able to be handled (drawn) and wound off.

Poly(vinylidene fluoride) (PVDF) and its derivatives exhibit an advantage as main constituent material of the separator for their electrochemical stability and for their high dielectric constant, which promotes the dissociation of the ions and thus the conductivity. The copolymer P(VDF-HFP) (copolymer of vinylidene fluoride (VDF) and of hexafluoropropylene (HFP)) has been studied as gelled membrane because it exhibits a lower crystallinity than PVDF. For this reason, the advantage of these P(VDF-HFP) copolymers is that they make it possible to achieve greater swellings and to thus promote the conductivity.

The document U.S. Pat. No. 5,296,318 describes compositions of solid electrolytes comprising a mixture of P(VDF-co-HFP) copolymer, of lithium salt and of compatible solvent having a moderate boiling point (i.e. of between 100° C. and 150° C.), which are capable of forming an extendable and self-supporting film. Example 2 describes the preparation of a film having a thickness of 100 μm from a composition containing a P(VDF-HFP) copolymer, LiPF₆ (lithium hexafluorophosphate) and a mixture of ethylene carbonate and propylene carbonate.

The composite solid electrolytes exhibit improved mechanical properties.

The publication by Kun Shi et al. in Journal of Membrane Science, 638 (2021), 119713, describes PVDF/PP/PVDF composites. The polypropylene (PP) is a Celgard 2400 microporous film. The PVDF is a homopolymer of HSV900 type from Shenzhen Kejing Star Technology Co. The composite contains 25% by weight of LiClO₄. A PVDF/PP/PVDF trilayer film of 100 μm displays an ion conductivity of 0.15 mS/cm at 25° C. and makes it possible to increase the Young's modulus from 24 to 102 MPa, in comparison with a PVDF monolayer. However, the trilayer is prepared in N,N-dimethylformamide (D) MF), and a not insignificant amount of free DMF remains trapped in the PVDF after drying, which limits the electrochemical stability.

There still exists a need to develop novel solid electrolytes which exhibit a good compromise between ion conductivity, electrochemical stability and temperature stability, and which are suitable for a simplified use compatible with an industrial application.

It is thus an aim of the invention to overcome at least one of the disadvantages of the prior art, namely to provide a solid electrolyte composition exhibiting performance qualities at least equivalent to those of a liquid electrolyte.

The invention also relates to a non-porous polymeric film consisting of said composition exhibiting good properties of mechanical strength, of ion conductivity and of electrochemical stability.

The invention is also targeted at providing at least one process for the manufacture of this polymeric film.

Another subject-matter of the invention is a separator, in particular for a Li-ion battery, consisting, in all or part, of said film. This separator can also be used in a battery, a capacitor, an electrochemical double layer capacitor, a membrane-electrode assembly (MEA) for a fuel cell or an electrochromic device.

Finally, the invention is targeted at providing all-solid-state batteries, in particular rechargeable Li-ion batteries, comprising such a separator.

### SUMMARY OF THE INVENTION

The invention relates firstly to a solid electrolyte composition consisting of a matrix constituted of following components a), b) and c):
a) at least one copolymer of vinylidene fluoride (VDF) and of at least one comonomer compatible with VDF,
b) at least one plasticizer,
c) at least one lithium salt,
and at least one mechanical reinforcement (component d)).

The term “comonomer compatible with VDF” is understood to mean a comonomer which can polymerize with VDF: these monomers are preferably chosen from vinyl fluoride, trifluoroethylene, chlorotrifluoroethylene (CTFE), 1,2-difluoroethylene, tetrafluoroethylene (TFE), hexafluoropropylene (HFP) or perfluoro (alkyl vinyl) ethers, such as perfluoro(methyl vinyl) ether (PMVE), perfluoro (ethyl vinyl) ether (PEVE) or perfluoro (propyl vinyl) ether (PPVE).

According to one embodiment, the VDF copolymer is a terpolymer.

According to one embodiment, the component a) is at least a copolymer of vinylidene fluoride (VDF) and of hexafluoropropylene (HFP), or P(VDF-HFP).

Advantageously, said P(VDF-HFP) copolymer has a content by weight of HFP of greater than or equal to 5% and less than or equal to 45%.

According to one embodiment, said lithium salt is chosen from the list: LiFSI, LiTFSI, LiTDI, LiPF₆, LIBF₄ and LiBOB.

The reinforcement consists of any material which makes it possible to improve the mechanical properties in comparison with the matrix alone.

The invention also relates to a non-porous film consisting of said solid electrolyte composition. Advantageously, the film does not contain a solvent having a low boiling point (namely less than 150° C.) and exhibits a high ion conductivity.

Another subject-matter of the invention is a separator, in particular for a rechargeable Li-ion battery, comprising a film as described.

The invention also relates to an electrochemical device chosen from the group: batteries, capacitor, electrochemical double layer electrical capacitor, and membrane-electrode assembly (MEA) for a fuel cell or an electrochromic device, said device comprising a separator as described.

Another subject-matter of the invention is a lithium-based all-solid-state battery, for example a Li-ion battery, or Li—S or Li-air batteries, comprising a negative electrode, a positive electrode and a separator, in which said separator comprises a film as described.

The invention also relates to an all-solid-state battery comprising such a non-porous film.

The present invention makes it possible to overcome the disadvantages of the state of the art. It more particularly provides a non-porous film capable of operating as all-solid-state battery separator which combines a high ion conductivity, good electrochemical stability, temperature stability and a mechanical strength sufficient to make possible easy handling.

The advantage of this invention is to offer a better guarantee of safety in comparison with a separator or an electrolyte based on liquid electrolyte, for electrochemical performance qualities at least equal to those of the liquid electrolytes. There is thus no possible escape of electrolyte and the flammability of the electrolyte is greatly reduced thereby.

Just like the liquid electrolytes, the solid electrolyte according to the invention can be used in a battery with an anode made of graphite, of silicon or of graphite and silicon. However, its resistance to the growth of dendrites at the surface of the anode also authorizes a lithium metal anode, which makes possible a saving in energy density in comparison with conventional Li-ion technologies.

### BRIEF DESCRIPTION OF THE FIGURES

FIG. 1 is a diagram representing the variation in the tensile strength as a function of the elongation for two films: the comparative film 1 and the film 2 according to the invention.

### DESCRIPTION OF EMBODIMENTS OF THE INVENTION

The invention is now described in more detail and in a non-limiting way in the description which follows.

According to a first aspect, the invention relates to a solid electrolyte composition consisting of a matrix constituted of following components a), b) and c):
a) at least one copolymer of vinylidene fluoride (VDF) and of at least one comonomer compatible with VDF,
b) at least one plasticizer,
c) at least one lithium salt,
and at least one mechanical reinforcement (component d)).

According to various implementations, said solid electrolyte film comprises the following features, if appropriate combined. The contents indicated are expressed by weight, unless otherwise indicated. The concentration ranges indicated comprise the limits, unless otherwise indicated.

### Component a)

Component a) consists of at least one copolymer comprising units of vinylidene difluoride (VDF) and one or more types of units of comonomers compatible with vinylidene difluoride (hereinafter referred to as “VDF copolymer”). The VDF copolymer contains at least 50% by weight of vinylidene difluoride, advantageously at least 70% by weight of VDF and preferably at least 80% by weight of VDF.

The comonomers compatible with vinylidene difluoride can be halogenated (fluorinated, chlorinated or brominated) or non-halogenated.

Examples of appropriate fluorinated comonomers are: vinyl fluoride, tetrafluoroethylene, hexafluoropropylene, trifluoropropenes and in particular 3,3,3-trifluoropropene, tetrafluoropropenes and in particular 2,3,3,3-tetrafluoropropene or 1,3,3,3-tetrafluoropropene, hexafluoroisobutylene, perfluorobutylethylene, pentafluoropropenes and in particular 1,1,3,3,3-pentafluoropropene or 1,2,3,3,3-pentafluoropropene, perfluoroalkyl vinyl ethers and in particular those of general formula Rf—O—CF═CF₂. Rf being an alkyl group, preferably a C₁ to C₄ alkyl group (preferred examples being perfluoropropyl vinyl ether and perfluoromethyl vinyl ether). The fluorinated monomer can comprise a chlorine or bromine atom. It can in particular be chosen from bromotrifluoroethylene, chlorofluoroethylene, chlorotrifluoroethylene and chlorotrifluoropropene, Chlorofluoroethylene can denote either 1-chloro-1-fluoroethylene or 1-chloro-2-fluoroethylene. The 1-chloro-1-fluorocthylene isomer is preferred. Chlorotrifluoropropene is preferably 1-chloro-3,3,3-trifluoropropene or 2-chloro-3,3,3-trifluoropropene.

According to one embodiment, the component a) consists of a VDF copolymer.

According to one embodiment, the component a) consists of a P(VDF-HFP) copolymer. Advantageously, the P(VDF-HFP) copolymer has a content by weight of HFP of greater than or equal to 5%, preferably of greater than or equal to 8%, advantageously of greater than or equal to 11%, and of less than or equal to 45%, preferably of less than or equal to 30%.

According to one embodiment, said component a) consists of a mixture of two VDF copolymers with different structures.

According to one embodiment, the component a) consists of a VDF copolymer to which is added a PVDF homopolymer in a proportion by weight ranging from 0% to 10%, based on the weight of said component a).

According to one embodiment, said component a) consists of a mixture of a PVDF homopolymer (in a proportion of up to 10%) and of a P(VDF-HFP) copolymer.

According to one embodiment, the VDF copolymer and/or the PVDF homopolymer participating in the composition of the component a) comprises monomer units bearing at least one of the following functions: carboxylic acid, carboxylic acid anhydride, carboxylic acid ester, epoxy (such as glycidyl), amide, hydroxyl, carbonyl, mercapto, sulfide, oxazoline, phenolic, ester, ether, siloxane, sulfonic, sulfuric, phosphoric or phosphonic. The function is introduced by a chemical reaction which can be grafting or a copolymerization of the fluorinated monomer with a monomer carrying at least one of said functional groups and a vinyl function capable of copolymerizing with the fluorinated monomer, according to techniques well known to a person skilled in the art.

According to one embodiment, the functional group carries a carboxylic acid function which is a group of (meth)acrylic acid type chosen from acrylic acid, methacrylic acid, hydroxyethyl (meth)acrylate, hydroxypropyl (meth)acrylate and hydroxyethylhexyl (meth)acrylate.

According to one embodiment, the units carrying the carboxylic acid function additionally comprise a heteroatom chosen from oxygen, sulfur, nitrogen and phosphorus.

The content of functional groups of the VDF copolymer and/or of the PVDF homopolymer participating in the composition of the component a) is at least 0.01 mol %, preferably at least 0.1 mol %, and at most 15 mol %, preferably at most 10 mol %.

According to one embodiment, the VDF copolymer has a high molecular weight. The term “high molecular weight”, as used here, is understood to mean a copolymer having a melt viscosity of greater than 100 Pa·s, preferably of greater than 500 Pa·s, more preferably of greater than 1000 Pa·s, according to the ASTM D-3835 method, measured at 232° C. and 100 sec-1.

The VDF copolymers used in the invention can be obtained by known polymerization methods, such as emulsion, solution or suspension polymerization.

According to one embodiment, they are prepared by an emulsion polymerization process in the absence of a fluorinated surface-active agent.

According to one embodiment, said VDF copolymer is a random copolymer. This type of copolymer exhibits the advantage of exhibiting a uniform distribution of the comonomer along the vinylidene fluoride chains.

According to one embodiment, said VDF copolymer is a “heterogeneous” copolymer which is characterized by a non-homogeneous distribution of the comonomer along the VDF chains, due to the process of synthesis described by the Applicant Company for example in the document U.S. Pat. No. 6,187,885 or in the document U.S. Pat. No. 10,570,230. A heterogeneous copolymer possesses two (or more)distinct phases, with a phase rich in PVDF homopolymer and a comonomer-rich copolymer phase.

According to one embodiment, the heterogeneous copolymer consists of non-continuous, discrete and individual copolymer domains of comonomer-rich phase, which are distributed homogeneously in a PVDF-rich continuous phase. The term “a non-continuous structure” is then used.

According to another embodiment, the heterogeneous copolymer is a copolymer having two (or more) continuous phases which are intimately bonded together and cannot be physically separated. The term “a co-continuous structure” is then used.

According to one embodiment, said heterogeneous copolymer comprises two or more co-continuous phases which comprise:
a) from 25% to 50% by weight of a first co-continuous phase comprising 90-100% by weight of vinylidene fluoride monomer units and 0% to 10% by weight of other fluoromonomer units, and
b) from more than 50% by weight to 75% by weight of a second co-continuous phase comprising from 65% to 95% by weight of vinylidene fluoride monomer units and an effective amount of one or more comonomers, such as hexafluoropropylene and perfluorovinyl ether, to bring about the phase separation of the second co-continuous phase from the first co-continuous phase.

The heterogeneous copolymer can be manufactured by forming an initial polymer which is rich in VDF monomer units, generally greater than 90% by weight of VDF, preferably greater than 95% by weight, and in a preferred embodiment a PVDF homopolymer, and by then adding a comonomer to the reactor at a well-advanced point of the polymerization in order to produce a copolymer. The polymer and the copolymer which are rich in VDF will form distinct phases, which will give an intimate heterogeneous copolymer.

The copolymerization of VDF with a comonomer, for example with HFP, results in a latex generally having a solids content of from 10% to 60% by weight, preferably from 10% to 50%, and having a weight-average particle size of less than 1 micrometre, preferably of less than 800 nm and more preferably of less than 600 nm. The weight-average size of the particles is generally at least 20 nm, preferably at least 50 nm, and advantageously the average size is within the range from 100 to 400 nm. The polymer particles can form agglomerates, the weight-average size of which is from 1 to 30 micrometres and preferably from 2 to 10 micrometres. The agglomerates can break up into discrete particles during the formulation and the application to a substrate.

The VDF copolymers used in the invention can form a gradient between the core and the surface of the particles, in terms of composition (content of comonomer, for example) and/or of molecular weight.

According to some embodiments, the VDF copolymers contain biobased VDF. The term “biobased” means “resulting from biomass”. This makes it possible to improve the ecological footprint of the membrane. Biobased VDF can be characterized by a content of renewable carbon, that is to say of carbon of natural origin originating from a biomaterial or from biomass, of at least 1 atom %, as determined by the content of ¹⁴C according to Standard NF EN 16640. The term “renewable carbon” indicates that the carbon is of natural origin and originates from a biomaterial (or from biomass), as indicated below. According to some embodiments, the biocarbon content of the VDF can be greater than 5%, preferably greater than 10%, preferably greater than 25%, preferably greater than or equal to 33%, preferably greater than 50%, preferably greater than or equal to 66%, preferably greater than 75%, preferably greater than 90%, preferably greater than 95%, preferably greater than 98%, preferably greater than 99%, advantageously equal to 100%.

### Component b)

The second component of the solid electrolyte composition of the invention consists of at least one plasticizer.

According to one embodiment, said plasticizer is an ionic liquid.

An ionic liquid is a liquid salt at ambient temperature, that is to say that it has a melting point of less than 100° C. under atmospheric pressure. It is formed by the combination of an organic cation and of an anion, the ionic interactions of which are sufficiently weak so as not to form a solid.

Mention may be made, as examples of organic cations, of the cations: ammonium, sulfonium, pyridinium, pyrrolidinium, imidazolium, imidazolinium, phosphonium, guanidinium, piperidinium, thiazolium, triazolium, oxazolium, pyrazolium and their mixtures. According to one embodiment, this cation can comprise a C₁-C₃₀ alkyl group, such as 1-butyl-1-methylpyrrolidinium, 1-ethyl-3-methylimidazolium, N-methyl-N-propylpyrrolidinium or N-methyl-N-butylpiperidinium.

According to one embodiment, the anions which are combined with them are chosen from: imides, in particular bis(fluorosulfonyl)imide and bis(trifluoromethanesulfonyl)imide; borates; phosphates; phosphinates and phosphonates, in particular alkylphosphonates; amides, in particular dicyanamide; aluminates, in particular tetrachloroaluminate; halides (such as bromide, chloride or iodide anions); cyanates; acetates (CH₃COO⁻), in particular trifluoroacetate; sulfonates, in particular methanesulfonate (CH₃SO₃⁻) or trifluoromethanesulfonate; and sulfates, in particular hydrogen sulfate.

According to one embodiment, the anions are chosen from tetrafluoroborate (BF₄⁻), bis(oxalato) borate (BOB⁻), hexafluorophosphate (PF₆⁻), hexafluoroarsenate (AsF₆⁻), triflate or trifluoromethylsulfonate (CF₃SO₃⁻), bis(fluorosulfonyl)imide (FSI⁻), bis(trifluoromethanesulfonyl)imide (TFSI⁻), nitrate (NO₃⁻) and 4.5-dicyano-2-(trifluoromethyl) imidazole (TDI⁻).

According to one embodiment, said anion of the ionic liquid is chosen from TDI⁻, FSI⁻, TFSI⁻, PF₆⁻. BF₄⁻, NO₃⁻; and BOB⁻.

According to one embodiment, said anion of the ionic liquid is FSI⁻.

According to one embodiment, said component b) is a mixture of at least two ionic liquids chosen from those described above.

According to one embodiment, the component b) of the solid electrolyte composition of the invention is a mixture of at least one ionic liquid and at least one solvent having a high boiling point (greater than 160° C.). According to one embodiment, said solvent is chosen from:
vinylene carbonate (VC) (CAS: 872-36-6),
fluoroethylene carbonate or 4-fluoro-1,3-dioxolan-2-one (FEC or FIEC) (CAS: 114435-02-8),
trans-4,5-difluoro-1,3-dioxolan-2-one (F2EC) (CAS: 171730-81-7),
ethylene carbonate (EC) (CAS: 96-49-1),
propylene carbonate (PC) (CAS: 108-32-7),
(2-cyanoethyl)triethoxysilane (CAS: 919-31-3),
3-methoxypropionitrile (CAS No. 110-67-8),
sulfolane (126-33-0),
ethers, such as polyethylene glycol dimethyl ethers, in particular diethylene glycol dimethyl ether (EG2DME), triethylene glycol dimethyl ether (EG3DME) and tetraethylene glycol dimethyl ether (EG4DME).

The plasticizers make it possible to obtain improved properties of conductivity, electrochemical stability, thermal stability, compatibility with electrodes, retention of capacity, in comparison with conventional liquid electrolytes.

Examples of component b) according to the invention are the following mixtures:
1-ethyl-3-methylimidazolium FSI and FEC,
1-ethyl-3-methylimidazolium FSI and tetraethylene glycol dimethyl ether,
1-butyl-1-methylpyrrolidinium FSI and FEC,
1-ethyl-3-methylimidazolium TFSI and FEC.
1-ethyl-3-methylimidazolium FSI,
1-butyl-1-methylpyrrolidinium FSI.

According to one embodiment, in the mixture of at least one ionic liquid and of a solvent, the ratio by weight of the ionic liquids to the solvents forming the component b) varies from 10:0.1 to 0.1:10.

### Component c)

The lithium salt present in the solid electrolyte composition comprises the same anion as those of the ionic liquid present in the component b).

According to one embodiment, said lithium salt is chosen from: LiPF₆, LiFSI, LiTFSI, LITDI, LiBF₄, LINO₃ and LiBOB.

### Component d)

The mechanical reinforcement consists of any material (porous membrane, woven or nonwoven) which makes it possible to improve the mechanical properties in comparison with the matrix alone (components a+b+c). It can, non-limitingly, be:
a microporous film based on polyolefins, such as polyethylene (PE), polyethylene terephthalate (PET), polypropylene (PP), Li-ion separator Celgard,
a porous film based on PVDF, on polyethersulfone (PES) or on polysulfone (PSU),
a woven substrate (for example PP, PE, PET, PVDF, PES, PSU, inorganic fibres),
a non-woven substrate of following type: melt blown (for example PP, PET, PVDF, PES, PSU), a spunbond substrate (for example PP, PET, PVDF. PES. PSU),
a cellulose separator,
short staple fibres, or
melt spun fibres.

According to one embodiment, the mechanical reinforcement is a multilayer material with at least one polyolefin layer and at least one inorganic layer, for example Celgard® PP coated with an alumina layer on both faces.

The mechanical reinforcement can be chosen from polymers (for example polyolefin, PVDF, PTFE, polyamide, polyimide, polyaramid, polybenzoaxoles, polybenzimidazoles, polybenzothiazoles, polyphosphazenes. PEKK, PEEK, PES, PSU), carbon fibres (for example vapour-grown carbon fibres (VGCF®)), carbon nanotubes (CNTs), inorganic fibres (for example glass fibres) and plant fibres (for example paper, lignin, cellulose, cellulose nanowhiskers).

According to one embodiment, the woven or non-woven consists of fibres and exhibits a weight per unit area of less than 50 g/m², preferably of less than 30 g/m², preferably of less than 20 g/m2 and advantageously of less than 15 g/m2.

According to one embodiment, the solid electrolyte composition consists of:
a) from 8% to 66.5% of VDF copolymer(s),
b) from 4% to 76% of plasticizer(s),
c) from 0.8% to 28.5% of lithium salt(s) and
d) from 5% to 60% of mechanical reinforcement,
the sum of all the constituents being 100%.

According to one embodiment, the solid electrolyte composition consists of:
from 18% to 45% of component a),
from 24% to 63% of component b),
from 1.8% to 9% of component c) and
from 10% to 40% of component d).

According to one embodiment, the solid electrolyte composition consists of a P(VDF-HFP) copolymer, an EMIM-FSI/EG4DME mixture, LiFSI and a PVDF non-woven in proportions by weight of 32/44.8/3.2/20, the EMIM-FSI/EG4DME ratio by weight being 1:1.

The invention also relates to a non-porous film or membrane consisting of said solid electrolyte composition. Advantageously, the film does not contain solvent and exhibits a high ion conductivity. Advantageously, the film is self-supporting, that is to say that it can be handled without the help of a support. Advantageously, the film is capable of being wound, that is to say that it can be handled so that it can be wound onto a reel.

According to one embodiment, said film exhibits a thickness of 5 μm to 60 μm, preferably of 5 μm to 30 μm, more preferentially of 7 μm to 20 μm.

According to one embodiment, the film according to the invention exhibits an ion conductivity ranging from 0.01 to 5 mS/cm, preferably from 0.05 to 5 mS/cm, advantageously from 0.5 to 5 mS/cm, at 25° C. The conductivity is measured by electrochemical impedance spectroscopy. According to one embodiment, the non-porous film is placed between two gold electrodes in a leaktight conductivity cell and under an inert atmosphere (CESH, Biologic) and electrochemical impedance spectroscopy is carried out between 1 Hz and 1 MHz with an amplitude of 10 mV. The resistance R of the film is subsequently determined by linear regression of the curve−Im (Z)=f (Re(Z)). The conductivity σ is then given by the following relationship:

$$σ = \frac{l}{R \times S}$$

where l is the thickness of the film and S its surface area. For each composition, the conductivity value at a given temperature is obtained by taking the mean over at least two measurements carried out on different samples.

Advantageously, the film according to the invention exhibits good electrochemical stability over the temperature range extending from −20° C. to 80° C.

Advantageously, the film according to the invention exhibits a content of solvent(s) having a boiling point of less than 150° C. of less than 1% by weight, preferably of less than 0.1%, preferably of less than 10 ppm.

Advantageously, the film retains its properties up to 80° C. and does not catch fire below 130° C.

According to one embodiment, the film according to the invention exhibits a mechanical strength characterized by an elastic modulus, measured at 1 Hz and 23° C. by dynamic mechanical analysis, of greater than 0.1 MPa, preferentially of greater than 1 MPa, more preferentially of greater than 10 MPa.

The invention is also targeted at providing at least one process for the manufacture of this non-porous polymeric film.

According to one embodiment, said film is manufactured by immersion in a solution containing a, b and c. Said at least one VDF copolymer is dissolved at ambient temperature in a solvent chosen from: N-methyl-2-pyrrolidone, dimethyl sulfoxide, dimethylformamide, methyl ethyl ketone, acetonitrile and acetone. Said at least one lithium salt is dissolved in a solution of at least one plasticizer, in order to obtain a lithium salt solution. The two solutions are mixed. A mechanical reinforcement is then immersed in the final solution. The film is subsequently dried, for example at 60° C. under vacuum overnight. In the case of acetone, it is possible to dry in a ventilated oven. A perfectly homogeneous and transparent self-supporting film is finally obtained.

According to one embodiment, said film is manufactured by coating. Said at least one VDF copolymer is dissolved at ambient temperature in a solvent chosen from: N-methyl-2-pyrrolidone, dimethyl sulfoxide, dimethylformamide, methyl ethyl ketone, acetonitrile and acetone. Said at least one lithium salt is dissolved in the ionic liquid/plasticizer mixture, in order to obtain a lithium salt solution. The two solutions are mixed.

A mechanical reinforcement is coated on one face or both faces, with the mixture thus obtained, for example using a doctor blade. The film is subsequently dried, for example at 60° C. under vacuum overnight. In the case of acetone, it is possible to dry in a ventilated oven. A perfectly homogeneous and transparent self-supporting film is finally obtained.

Another subject-matter of the invention is a separator for an all-solid-state battery consisting, in all or part, of said film.

The invention also relates to an electrochemical device chosen from the group: batteries, capacitor, electrochemical double layer electrical capacitor, and membrane-electrode assembly (MEA) for a fuel cell or an electrochromic device, said device comprising a separator as described.

Another subject-matter of the invention is an all-solid-state battery, for example a Li-ion battery, or Li—S or Li-air batteries, comprising a negative electrode, a positive electrode and a separator, in which said separator comprises a film as described above.

According to one embodiment, said battery comprises a lithium metal anode.

The invention also relates to an all-solid-state battery comprising an anode, a cathode and a separator, in which the anode and/or the cathode comprise such a non-porous film.

### EXAMPLES

The following examples illustrate the scope of the invention in a non-limiting manner.

### 1. Preparation of a Solid Electrolyte for a Li-Ion Battery Separator by Immersion

0.4 g of P(VDF-HFP) (poly(vinylidene fluoride)-co-hexafluoropropylene) (containing 11% of HFP by weight) is dissolved in 1.93 g of acetone at ambient temperature. Furthermore, 0.056 g of LiFSI (lithium bis(fluorosulfonyl)imide) is dissolved in 0.276 g of EMIM-FSI (1-ethyl-3-methylimidazolium bis(fluorosulfonyl)imide) and 0.281 g of tetraethylene glycol dimethyl ether (EG4DME). The latter solution is added to the P(VDF-HFP) solution and then mixed. A polypropylene non-woven (thickness 40 μm, porosity approximately 50%, weight per unit area 18 g/m2) is then immersed for 5 min in the final solution. Drying is subsequently carried out at 60° C. under vacuum overnight. A transparent self-supporting film of approximately 60 μm is finally obtained.

The residual solvent is measured by GC-MS. The amount of acetone is less than the detection limit of this technique, i.e. 10 ppm.

### 2. Preparation of a Solid Electrolyte for a Li-Ion Battery Separator by Coating

A solid electrolyte of the same composition as Example 1 is prepared with a different impregnation process. 0.4 g of P(VDF-HFP) (containing 11% of HFP by weight) is dissolved in 1.93 g of acetone at ambient temperature. Furthermore. 0.056 g of LiFSI (lithium bis(fluorosulfonyl)imide) is dissolved in 0.276 g of EMIM-FSI (1-ethyl-3-methylimidazolium bis(fluorosulfonyl)imide) and 0.281 g of tetraethylene glycol dimethyl ether (EG4DME). The latter solution is added to the P(VDF-HFP) solution and then mixed. The final solution is then coated onto a polypropylene non-woven (thickness 40 μm, porosity approximately 50%, weight per unit area 18 g/m²) using a doctor blade. The height of the doctor blade is greater than the thickness of the non-woven. Drying is subsequently carried out at 60° C. under vacuum overnight. A transparent self-supporting film of approximately 60 μm is finally obtained.

The residual solvent is measured by GC-MS. The amount of acetone is less than the detection limit of this technique, i.e. 10 ppm.

3. Measurement of the Conductivity of an all-Solid-State Separator

The conductivity is evaluated by electrochemical impedance spectroscopy by placing the solid electrolyte (prepared under an inert atmosphere) between the two gold electrodes of a leaktight conductivity cell and under an inert atmosphere (CESH, Biologic). 0.26 mS/cm is measured at 25° C. on the immersed solid electrolyte and 0.21 mS/cm is measured at 25° C. on the coated solid electrolyte.

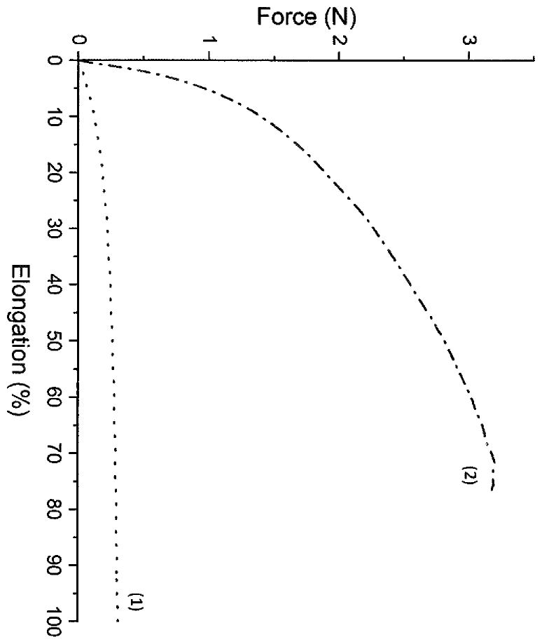

The result of a tensile test carried out on two solid electrolyte films is shown in FIG. 1, in the form of a graph exhibiting the tensile force applied to each test specimen as a function of the elongation. The film (1) is composed solely of a polymer matrix without mechanical reinforcement, while the film (2) is composed of a matrix (the same matrix as the film (1)) with a mechanical reinforcement in the form of a polypropylene non-woven.

These results show that, in order to elongate the film by 10%, it is necessary to apply a force approximately 10 times greater in the case of the film containing a mechanical reinforcement.

1. A solid electrolyte composition consisting of a matrix constituted of following components a), b) and c):
a) at least one copolymer of vinylidene fluoride (VDF) and of at least one comonomer compatible with VDF,
b) at least one plasticizer,
c) at least one lithium salt,
and at least one mechanical reinforcement (component d)).

2. The solid electrolyte composition of claim 1, in which said comonomer is selected from the group consisting of vinyl fluoride, trifluoroethylene, chlorotrifluoroethylene, 1,2-difluoroethylene, tetrafluorocthylene, hexafluoropropylene, perfluoro(methyl vinyl) ether, perfluoro (ethyl vinyl) ether and perfluoro (propyl vinyl) ether.

3. The solid electrolyte composition of claim 1, wherein said at least one copolymer is a copolymer of vinylidene fluoride and hexafluoropropylene (HFP) having a content by weight of HFP of greater than or equal to 5%, and less than or equal to 45%.

4. The solid electrolyte composition of claim 1, wherein said plasticizer comprises an ionic liquid which comprises an anion selected from the group consisting of tetrafluoroborate (BF₄⁻), bis(oxalato) borate (BOB⁻), hexafluorophosphate (PF₆), hexafluoroarsenate (AsF₆⁻), triflate, trifluoromethylsulfonate (CF₃SO₃⁻), bis(fluorosulfonyl)imide (FSI⁻), bis(trifluoromethanesulfonyl)imide (TFSI⁻), nitrate (NO₃⁻), 4,5-dicyano-2-(trifluoromethyl) imidazole (TDI⁻) and a cation selected from the group consisting of ammonium, sulfonium, pyridinium, pyrrolidinium, imidazolium, imidazolinium, phosphonium, guanidinium, piperidinium, thiazolium, triazolium, oxazolium, pyrazolium, and their mixtures.

5. The solid electrolyte composition of claim 1, wherein said plasticizer is a mixture of at least one ionic liquid and of at least one solvent having a boiling point of greater than 160° C., said solvent selected from the group consisting of: vinylene carbonate, fluoroethylene carbonate, trans-4,5-difluoro-1,3-dioxolan-2-one, ethylene carbonate, propylene carbonate, (2-cyanoethyl)triethoxysilane, 3-methoxypropionitrile, sulfolane and polyethylene glycol dimethyl ethers.

6. The solid electrolyte composition of claim 1, wherein said lithium salt is selected from the group consisting of: LiPF₆, LIFSI, LiTFSI, LiTDI, LiBF₄, LINO₃ and LiBOB.

7. The solid electrolyte composition of claim 1, wherein said reinforcement is chosen from the list: microporous film, woven substrate, non-woven substrate of melt blown or spunbond type, cellulose separator, short staple fibres or melt spun fibres.

8. The solid electrolyte composition of claim 1, wherein Composition according to any one of claims 1 to 6, in which said reinforcement is selected from the group consisting of: polymers, carbon fibres, carbon nanotubes, inorganic fibres and plant fibres.

9. The solid electrolyte composition of claim 1, wherein said reinforcement comprises: polymer, selected from the group consisting of polyolefin, PVDF, PTFE, polyamide, polyimide, polyaramid, polybenzoaxoles, polybenzimidazoles, polybenzothiazoles, polyphosphazenes, PEKK, PEEK, PES or PSU;

[symbol]

10. The solid electrolyte composition of claim 1 consisting of:
a) from 8% to 66.5% of VDF copolymer(s),
b) from 4% to 76% of plasticizer(s),
c) from 0.8% to 28.5% of lithium salt(s), and
d) from 5% to 60% of mechanical reinforcement(s),
the sum of all the constituents being 100%.

11. A non-porous film consisting of the solid electrolyte composition of claim 1 and optionally solvent.

12. The non-porous film of claim 11, exhibiting a content of solvent(s) having a boiling point of less than 150° C. of less than 1% by weight.

13. The non-porous film of claim 11, exhibiting an ion conductivity of from 0.01 to 5 mS/cm at 25° C., measured by electrochemical impedance spectroscopy.

14. A process for the preparation of the film of claim 11 by immersion, said process comprising the steps of:
i-dissolving said at least one VDF copolymer at ambient temperature in a solvent selected from the group consisting of: N-methyl-2-pyrrolidone, dimethyl sulfoxide, dimethylformamide, methyl ethyl ketone, acetonitrile and acetone; to obtain a VDF copolymer solution,
ii-dissolving said at least one lithium salt in the plasticizer, to obtain a lithium salt solution;
iii-mixing the VDF copolymer solution and the lithium salt solutions, to obtain a mixture
iv-immersing a fibrous reinforcement in the mixture,
v-drying the fibrous reinforcement after the immersion step iv.

15. A process for the preparation of the film claim 11 by coating, said process comprising the steps of:
i-dissolving said at least one VDF copolymer at ambient temperature in a solvent selected from the group consisting of: N-methyl-2-pyrrolidone, dimethyl sulfoxide, dimethylformamide, methyl ethyl ketone, acetonitrile and acetone;
ii-dissolving said at least one lithium salt in the plasticizer, to obtain a lithium salt solution;
iii-mixing the VDF copolymer solution and the lithium salt solutions, to obtain a mixture
iv-coating a fibrous reinforcement with the mixture, to obtain a coated fibrous reinforcement
v-drying the coated fibrous reinforcement.

16. A separator for a rechargeable Li-ion battery, comprising the film of claim 11.

17. An electrochemical device selected from the group consisting of: batteries, capacitor, electrochemical double layer electrical capacitor, fuel cell membrane-electrode assembly (MEA) and an electrochromic membrane-electrode assembly, said electrochemical device comprising the film of claim 11.

18. An all-solid-state battery comprising an anode, a cathode and a separator, in which said separator comprises the film of claim 11.

19. An all-solid-state battery comprising an anode, a cathode and a separator, in which the anode and/or the cathode comprise the non-porous film of claim 11.
